(19) United States
(12) Patent Application Publication
(10) Pub. No.: US 2025/0388121 A1
(43) Pub. Date: Dec. 25, 2025

(54) VOCATIONAL VEHICLE WITH SWAPPABLE BATTERY

(71) Applicant: Oshkosh Corporation, Oshkosh, WI (US)

(72) Inventors: Chad Smith, Oshkosh, WI (US); Peng Yang, Oshkosh, WI (US)

(73) Assignee: Oshkosh Corporation, Oshkosh, WI (US)

(21) Appl. No.: 19/246,634

(22) Filed: Jun. 23, 2025

Related U.S. Application Data
(60) Provisional application No. 63/663,674, filed on Jun. 24, 2024.

(51) Int. Cl. B60L 53/80; B60H 1/22; B60H 1/32; B60K 6/28; B60K 11/00; B60L 1/00

(52) U.S. Cl. CPC B60L 53/80; B60H 1/2225; B60H 1/3222; B60K 11/00; B60L 1/003; B60K 6/28

(57) ABSTRACT

An electrified vehicle includes a chassis, a plurality of tractive elements coupled to the chassis, a plurality of electric axles coupled to at least one of the plurality of tractive elements, a battery interface, a swappable battery configured to be selectively connected to or removed from the battery interface, and a power distribution unit configured to receive electrical power from the swappable battery and supply the electrical power to the plurality of electric axles.

### CROSS-REFERENCE TO RELATED PATENT APPLICATIONS

This application claims the benefit of and priority to U.S. Provisional Patent Application No. 63/663,674, filed on Jun. 24, 2024, which is incorporated herein by reference in its entirety.

### BACKGROUND

Electric vehicles typically include specialized equipment that is tailored for specific applications. For example, a refuse vehicle may include a vehicle body that includes a lift system to engage and discharge the contents of a refuse container into the vehicle body, whereas a mixer truck may include a drum system to rotate a concrete mixing drum that is coupled to a vehicle chassis.

### SUMMARY

In some aspects, the present disclosure relates to a vocational vehicle, including: a chassis; a plurality of tractive elements coupled to the chassis; a plurality of electric axles coupled to at least one of the plurality of tractive elements; a battery interface; a swappable battery configured to be selectively connected to or removed from the battery interface; and a power distribution unit configured to receive electrical power from the swappable battery and supply the electrical power to the plurality of electric axles.

In some aspects, the present disclosure relates to a vocational vehicle, including: a chassis; a plurality of tractive elements coupled to the chassis; an electric axle coupled to at least one of the plurality of tractive elements; a primary battery; a battery interface; a swappable battery configured to be selectively connected to or removed from the battery interface; and a power distribution unit configured to receive electrical power from the swappable battery and selectively supply the electrical power to the electric axle, wherein the power distribution unit is configured to detect that the swappable battery is removed from the battery interface and inhibit the primary battery from providing electrical power to the electric axle.

In some aspects, the present disclosure relates to a system for powering a vocational vehicle, including: a plurality of battery interfaces; a plurality of swappable batteries, each being removably coupled to one of the plurality of battery interfaces; a power distribution unit configured to receive electrical power from the plurality of swappable batteries and provide the electrical power to a plurality of electronic components of the vocational vehicle; and a cooling system configured to cool the plurality of swappable batteries, wherein each of the plurality of battery interfaces includes a cooling port that enables cooling fluid to flow to and from the plurality of swappable batteries.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a left side view of a vehicle, according to an exemplary embodiment;

FIG. 2 is a perspective view of the vehicle of FIG. 1 configured as a refuse vehicle, according to an exemplary embodiment;

FIG. 3 is a perspective view of the vehicle of FIG. 1 configured as a mixer vehicle, according to an exemplary embodiment;

FIG. 4 is a perspective view of the vehicle of FIG. 1 configured as a fire fighting vehicle, according to an exemplary embodiment;

FIG. 5 is a left side view of the vehicle of FIG. 1 configured as an airport fire fighting vehicle, according to an exemplary embodiment;

FIG. 6 is a perspective view of the vehicle of FIG. 1 configured as a boom lift, according to an exemplary embodiment;

FIG. 7 is a perspective view of the vehicle of FIG. 1 configured as a scissor lift, according to an exemplary embodiment;

FIG. 8 is a rear perspective view of the vehicle of FIG. 1 configured as a delivery vehicle, according to an exemplary embodiment;

FIG. 9 is a schematic illustration of an electrical power system of a vocational vehicle including a swappable auxiliary battery, according to an exemplary embodiment;

FIG. 10 is a schematic illustration of the electrical power system of FIG. 9 during a battery swap;

FIG. 11 is a schematic illustration of the electrical power system of FIG. 9 with the swappable auxiliary battery pack charging a primary battery;

FIG. 12 is a schematic illustration of the electrical power system of FIG. 9 with the swappable auxiliary battery removed;

FIG. 13 is a schematic illustration of the electrical power system of FIG. 9 during operation;

FIG. 14 is a schematic illustration of an electrical power system of a vocational vehicle including a swappable auxiliary battery integrated into a hybrid drivetrain, according to an exemplary embodiment;

FIG. 15 is a schematic illustration of an electrical power system of a vocational vehicle including a swappable batteries, according to an exemplary embodiment;

FIG. 16 is a schematic illustration of the electrical power system of FIG. 15 during operation;

FIG. 17 is a schematic illustration of the electrical power system of FIG. 15 with a swappable battery removed;

FIG. 18 is a schematic illustration of the electrical power system of FIG. 15 during a battery swap;

FIG. 19 is a schematic illustration of the electrical power system of FIG. 15 with all swappable batteries removed;

FIG. 20 is a schematic illustration of an electrical power system of a vocational vehicle including a swappable batteries integrated into a hybrid drivetrain, according to an exemplary embodiment;

FIG. 21 is a schematic illustration of the electrical power system of FIG. 20 with all swappable batteries removed;

FIG. 22 is a schematic illustration of a pass-through cooling system for an electric power system including swappable batteries, according to an exemplary embodiment;

FIG. 23 is a schematic illustration of a pass-through cooling system for charging station, according to an exemplary embodiment;

FIG. 24 is a schematic illustration of a built-in cooling system for a swappable battery, according to an exemplary embodiment;

FIG. 25A-D are a schematic illustrations of a battery pack module, according to various exemplary embodiments;

FIG. 26 is a perspective view of a swappable battery pack for a vocational vehicle, according to an exemplary embodiment; and

FIG. 27 is a perspective view of the swappable battery pack of FIG. 26.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Vehicle

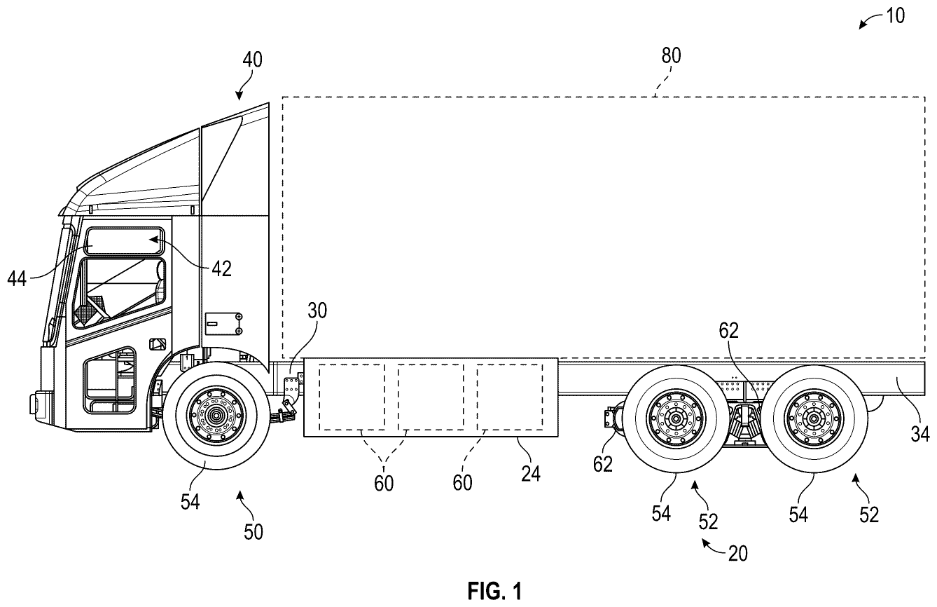

According to an exemplary embodiment, as shown in FIG. 1, an electrified vehicle (e.g., a vehicle assembly, a vocational vehicle, a truck, a vehicle base, etc.), shown as vehicle 10, includes a frame assembly or chassis assembly, shown as chassis 20. The chassis assembly may support other components of the vehicle 10. In some embodiments, the chassis 20 extends longitudinally along a length of the vehicle 10. The chassis 20 may extend substantially parallel to a primary direction of travel of the vehicle 10. In some embodiments, the chassis 20 includes a middle section 24 that acts as a storage portion that includes one or more vehicle components. The middle section 24 may include an enclosure that contains one or more vehicle components and/or a frame that supports one or more vehicle components. In some embodiments, the middle section 24 contains or includes one or more electrical energy storage devices (e.g., batteries, capacitors, etc.).

According to an exemplary embodiment, a cabin, operator compartment, or body component, shown as cab 40, is coupled to a front end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42 that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. In one embodiment, the cab interior 42 contains components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

According to an exemplary embodiment, the vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. In one embodiment, the vehicle 10 includes a tag axle that may be raised or lowered to accommodate variations in weight being carried by the vehicle 10. The front axle 50 and the rear axles 52 each include a plurality of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle 10.

In some embodiments, the vehicle 10 is configured as an electric vehicle that is propelled by an electric powertrain system. As shown in FIG. 1, the vehicle 10 includes one or more electrical energy storage devices (e.g., batteries, battery packs, battery cells, capacitors, etc.), shown as batteries 60. As shown, the batteries 60 are supported on the chassis 20 (e.g., between the frame rails of the chassis 20). In other embodiments, the batteries 60 are otherwise positioned throughout the vehicle 10. The vehicle 10 further includes one or more electromagnetic devices (e.g., motor/generators), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 54 and provide electrical energy to the batteries 60, providing a braking force to slow the vehicle 10. As shown, the drive motors 62 are positioned within the rear axles 52 (e.g., as part of a combined axle and motor assembly). In other embodiments, the drive motors 62 are otherwise positioned within the vehicle 10 or within the axle assemblies.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system includes a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide the front axle 50 and/or the rear axles 52 to propel the vehicle 10. Additionally or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 is further be configured to support non-hybrid powertrains. For example, the powertrain system may include a primary driver that is a compression-ignition internal combustion engine that utilizes diesel fuel.

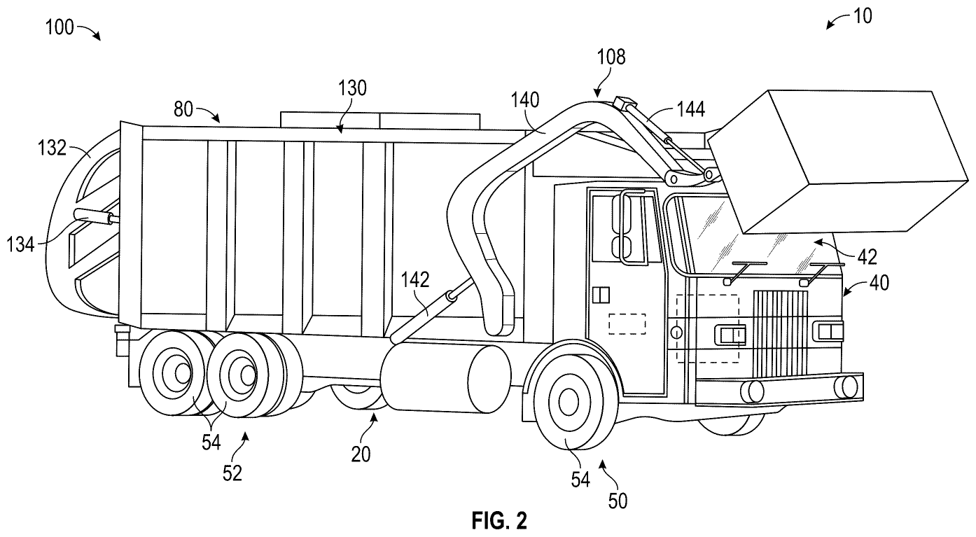

As shown in FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, a common vehicle 10 can be configured for a variety of different uses simply by selecting an appropriate application kit 80. By way of example, the vehicle 10 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. FIGS. 2-7 illustrate various examples of how the vehicle 10 may be configured for specific applications. Although only a certain set of vehicle configurations is shown, it should be understood that the vehicle 10 may be configured for use in other applications that are not shown.

According to an exemplary embodiment, the application kit 80 includes various actuators to facilitate certain functions of the vehicle 10. In one embodiment, the application kit 80 includes hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. In another embodiment, the application kit 80 includes hydraulic or pneumatic components that form a hydraulic or pneumatic circuit (e.g., conduits, valves, pumps, compressors, gauges, reservoirs, accumulators, etc.). By way of another embodiment, the application kit 80 includes electrical components (e.g., batteries, capacitors, voltage regulators, motor controllers, etc.). The actuators may be powered by components of the vehicle 10. In some embodiments, the actuators are powered by the batteries 60, the drive motors 62, or the primary driver (e.g., through a power take off).

As shown in FIG. 2, the vehicle 10 is configured as a refuse vehicle 100 (e.g., a refuse truck, a garbage truck, a waste collection truck, a sanitation truck, a recycling truck, etc.). Specifically, the refuse vehicle 100 is a front-loading refuse vehicle. In other embodiments, the refuse vehicle 100 is configured as a rear-loading refuse vehicle or a side-loading refuse vehicle.

As shown in FIG. 2, the application kit 80 of the refuse vehicle 100 includes a rear body or container, shown as refuse compartment 130, and a pivotable rear portion, shown as tailgate 132. The refuse compartment 130 may facilitate transporting refuse from various waste receptacles within a municipality to a storage and/or a processing facility (e.g., a landfill, an incineration facility, a recycling facility, etc.). According to an exemplary embodiment, loose refuse is placed into the refuse compartment 130 to be compacted. The refuse compartment 130 may also provide temporary storage for refuse during transport to a waste disposal site and/or a recycling facility. In some embodiments, the refuse compartment 130 includes a hopper volume and storage volume. In this regard, refuse may be initially loaded into the hopper volume and later compacted into the storage volume. According to an exemplary embodiment, the hopper volume is positioned between the storage volume and the cab 40 (e.g., refuse is loaded into a position of the refuse compartment 130 behind the cab 40 and stored in a position further toward the rear of the refuse compartment 130). In other embodiments, the storage volume is positioned between the hopper volume and the cab 40 (e.g., in a rear-loading refuse truck, etc.). The tailgate 132 may be pivotally coupled to the refuse compartment 130, and may be movable between a closed position and an open position by an actuator (e.g., a hydraulic cylinder, an electric linear actuator, etc.), shown as tailgate actuator 134 (e.g., to facilitate emptying the storage volume).

As shown in FIG. 2, the refuse vehicle 100 also includes an implement, shown as lift assembly 108 (e.g., a front-loading lift assembly, etc.). According to an exemplary embodiment, the lift assembly 108 includes a pair of lift arms 140, lift arm actuators 142, and articulation actuators 144. The lift arms 140 may be rotatably coupled to the chassis 20. In another embodiment, the lift arms 140 are rotatably coupled to the refuse compartment 30 on each side of the refuse vehicle 100 (e.g., through a pivot, a lug, a shaft, etc.). Such an embodiment provides that the lift assembly 108 extends forward relative to the cab 40 (e.g., a front-loading refuse truck, etc.). In other embodiments, the lift assembly 108 extends rearward relative to the application kit 80 (e.g., a rear-loading refuse truck). In yet other embodiments, the lift assembly 108 extends from a side of the application kit 80 (e.g., a side-loading refuse truck). The lift arm actuators 142 are positioned such that extension and retraction of the lift arm actuators 142 rotates the lift arms 140 about an axis extending through the pivot. In this regard, the lift arms 140 may be rotated by the lift arm actuators 142 to lift a refuse container over the cab 40. In an exemplary embodiment, the articulation actuators 144 are positioned to articulate the distal end of the lift arms 140 (e.g., a portion of the lift arms 140 that may be coupled to the refuse container) in order to assist in tipping refuse out of the refuse container and into the refuse compartment 130. The lift arm actuators 142 may then rotate the lift arms 140 to return the empty refuse container to the ground.

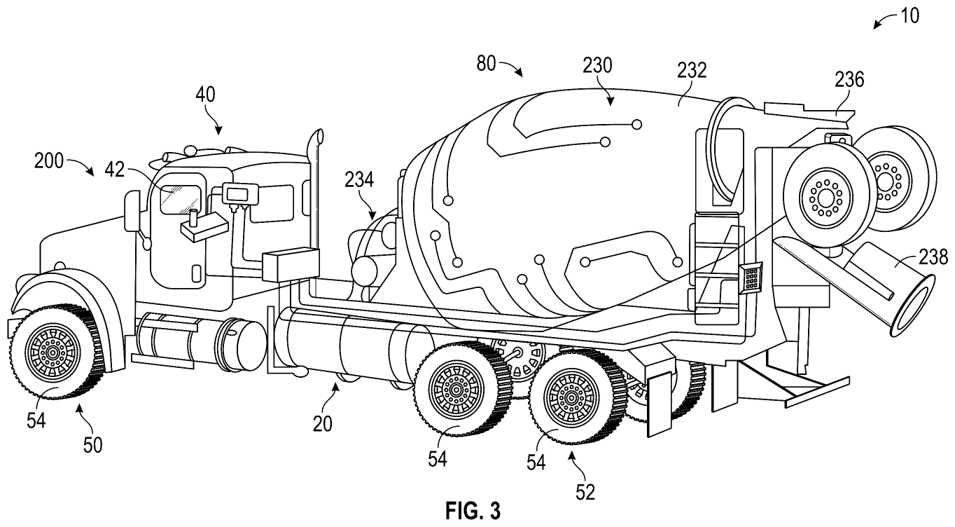

According to another exemplary embodiment, as shown in FIG. 3, the vehicle 10 is configured as a mixer truck (e.g., a concrete mixer truck, a mixer vehicle, etc.), shown as mixer truck 200. Specifically, the mixer truck 200 is a rear-discharge concrete mixer truck. In other embodiments, the mixer truck 200 is a front-discharge concrete mixer truck.

As shown in FIG. 3, the application kit 80 includes a mixing drum assembly (e.g., a concrete mixing drum), shown as drum assembly 230. The drum assembly 230 includes a mixing drum 232, a drum drive system 234 (e.g., a rotational actuator or motor), an inlet, shown as hopper 236, and an outlet, shown as chute 238. The mixing drum 232 may be coupled to the chassis 20 and may be disposed behind the cab 40 (e.g., at the rear and/or middle of the chassis 20). In an exemplary embodiment, the drum drive system 234 is coupled to the chassis 20 and configured to selectively rotate the mixing drum 232 about a central, longitudinal axis. According to an exemplary embodiment, the central, longitudinal axis of the mixing drum 232 is elevated from the chassis 20 (e.g., from a horizontal plan extending along the chassis 20) at an angle in the range of five degrees to twenty degrees. In other embodiments, the central, longitudinal axis is elevated by less than five degrees (e.g., four degrees, etc.). In yet another embodiment, the mixer truck 200 includes an actuator positioned to facilitate adjusting the central, longitudinal axis to a desired or target angle (e.g., manually in response to an operator input/command, automatically according to a control system, etc.).

The mixing drum 232 may be configured to receive a mixture, such as a concrete mixture (e.g., cementitious material, aggregate, sand, etc.), through the hopper 236. In some embodiments, the mixer truck 200 includes an injection system (e.g., a series of nozzles, hoses, and/or valves). The injection system may include an injection valve that selectively fluidly couples a supply of fluid to the inner volume of the mixing drum 232. In one embodiment, the injection system is used to inject water and/or chemicals (e.g., air entrainers, water reducers, set retarders, set accelerators, superplasticizers, corrosion inhibitors, coloring, calcium chloride, minerals, and/or other concrete additives, etc.) into the mixing drum 232. The injection valve may facilitate injecting water and/or chemicals from a fluid reservoir (e.g., a water tank, etc.) into the mixing drum 232, while preventing the mixture in the mixing drum 232 from exiting the mixing drum 232 through the injection system. In some embodiments, one or more mixing elements (e.g., fins, etc.) are positioned in the interior of the mixing drum 232, and may be configured to agitate the contents of the mixture when the mixing drum 232 is rotated in a first direction (e.g., counterclockwise, clockwise, etc.), and drive the mixture out through the chute 238 when the mixing drum 232 is rotated in a second direction (e.g., clockwise, counterclockwise, etc.). In some embodiments, the chute 238 includes an actuator positioned such that the chute 238 may be selectively pivotable to position the chute 238 (e.g., vertically, laterally, etc.), for example, at an angle at which the mixture is expelled from the mixing drum 232.

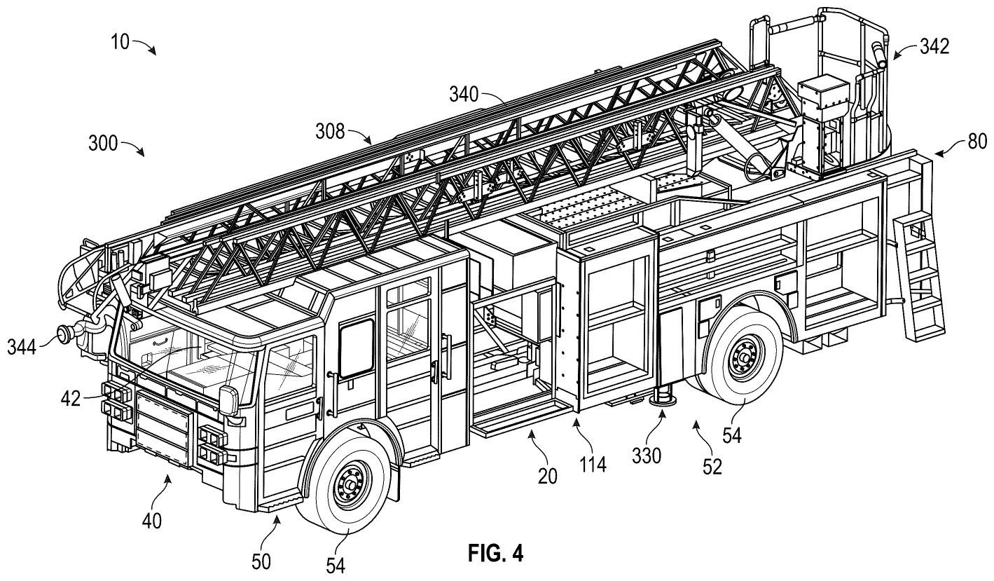

As shown in FIG. 4, the vehicle 10 is configured as a fire fighting vehicle or fire apparatus (e.g., a turntable ladder truck, a pumper truck, a quint, etc.), shown as fire fighting vehicle 300. As shown in FIG. 4, the fire fighting vehicle 300 is configured as a rear-mount aerial ladder truck. In other embodiments, the fire fighting vehicle 300 is configured as a mid-mount aerial ladder truck, a quint fire truck (e.g., including an on-board water storage, a hose storage, a water pump, etc.), a tiller fire truck, a pumper truck (e.g., without an aerial ladder), or another type of response vehicle. According to an exemplary embodiment, the vehicle 10 is be configured as a police vehicle, an ambulance, a tow truck, or still other vehicles used for responding to a scene (e.g., an accident, a fire, an incident, etc.).

As shown in FIG. 4, in the fire fighting vehicle 300, the application kit 80 is positioned mainly rearward from the cab 40. The application kit 80 includes deployable stabilizers (e.g., outriggers, downriggers, etc.), shown as outriggers 330, that are coupled to the chassis 20. The outriggers 330 may be configured to selectively extend from each lateral side and/or the rear of the fire fighting vehicle 300 and engage a support surface (e.g., the ground) in order to provide increased stability while the fire fighting vehicle 300 is stationary. This increased stability is desirable when the ladder assembly 308 is in use (e.g., extended from the fire fighting vehicle 300) to prevent tipping. In some embodiments, the application kit 80 further includes various storage compartments (e.g., cabinets, lockers, etc.) that are selectively opened and/or accessed for storage and/or component inspection, maintenance, and/or replacement.

As shown in FIG. 4, the application kit 80 includes a ladder assembly 308 coupled to the chassis 20. The ladder assembly 308 includes a series of ladder sections 340 that are slidably coupled with one another such that the ladder sections 340 may extend and/or retract (e.g., telescope) relative to one another to selectively vary a length of the ladder assembly 308. A base platform, shown as turntable 342, is rotatably coupled to the chassis 20 and to a proximal end of a base ladder section 340 (i.e., the most proximal of the ladder sections 340). The turntable 342 may be configured to rotate about a vertical axis relative to the chassis 20 to rotate the ladder sections 340 about the vertical axis (e.g., up to 360 degrees, etc.). The ladder sections 340 may rotate relative to the turntable 342 about a substantially horizontal axis to selectively raise and lower the ladder sections 340 relative to the chassis 20. As shown, a water turret or implement, shown as monitor 344, is coupled to a distal end of a fly ladder section 340 (i.e., the most distal of the ladder sections 340). The monitor 344 may be configured to expel water and/or a fire suppressing agent (e.g., foam, etc.) from a water storage tank and/or an agent tank onboard the fire fighting vehicle 300, and/or from an external source (e.g., a fire hydrant, a separate water/pumper truck, etc.). In some embodiments, the ladder assembly 308 further includes an aerial platform coupled to the distal end of the fly ladder section 340 and configured to support one or more operators.

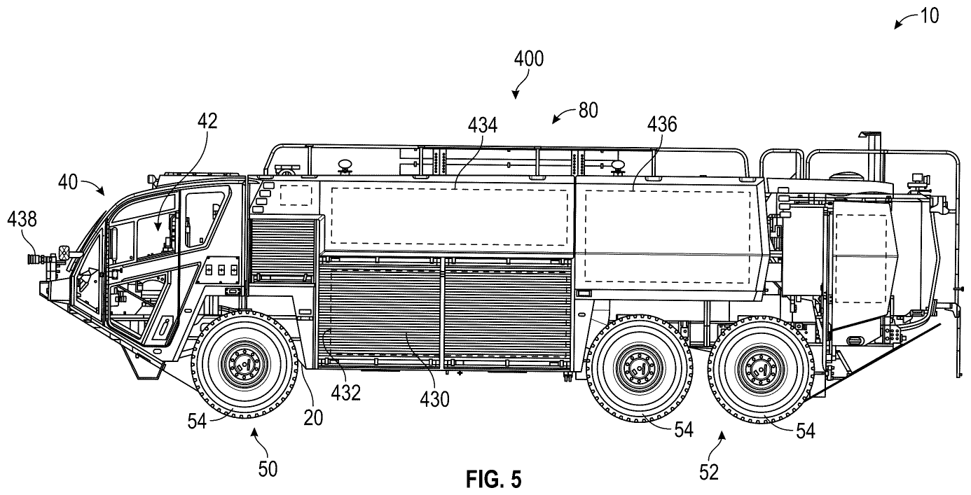

According to another exemplary embodiment, as shown in FIG. 5, the vehicle 10 is configured as a fire fighting vehicle, shown as airport rescue and fire fighting (ARFF) truck 400. As shown in FIG. 5, the application kit 80 is positioned primarily rearward of the cab 40. As shown, the application kit 80 includes a series of storage compartments or cabinets, shown as compartments 430, that are coupled to the chassis 20. The compartments 430 may store various equipment or components of the ARFF truck 400.

The application kit 80, as shown in FIG. 5, includes a pump system 432 (e.g., an ultra-high-pressure pump system, etc.) positioned within one of the compartments 430 near the center of the ARFF truck 400. The application kit 80 further includes a water tank 434, an agent tank 436, and an implement or water turret, shown as monitor 438. The pump system 432 may include a high pressure pump and/or a low pressure pump, which may be fluidly coupled to the water tank 434 and/or the agent tank 436. The pump system 432 may to pump water and/or fire suppressing agent from the water tank 434 and the agent tank 436, respectively, to the monitor 438. The monitor 438 may be selectively reoriented by an operator to adjust a direction of a stream of water and/or agent. As shown in FIG. 5, the monitor 438 is coupled to a front end of the cab 40.

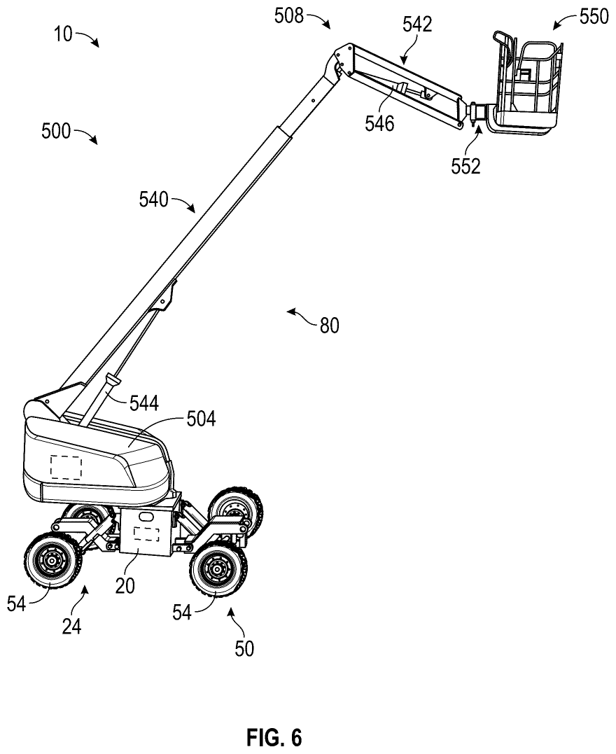

As shown in FIG. 6, the vehicle 10 is configured as a lift device, shown as boom lift 500. The boom lift 500 may be configured to support and elevate one or more operators. In other embodiments, the vehicle 10 is configured as another type of lift device that is configured to lift operators and/or material, such as a skid-loader, a telehandler, a scissor lift, a fork lift, a vertical lift, and/or any other type of lift device or machine.

As shown in FIG. 6, the application kit 80 includes a base assembly, shown as turntable 504 that is rotatably coupled to the chassis 20. The turntable 504 may be configured to selectively rotate relative to the chassis 20 about a substantially vertical axis. In some embodiments, the turntable 504 includes a counterweight positioned near the rear of the turntable 504. The turntable 504 is rotatably coupled to a lift assembly, shown as boom assembly 508. The boom assembly 508 includes a first section or telescoping boom section, shown as lower boom 540. The lower boom 540 includes a series of nested boom sections that extend and retract (e.g., telescope) relative to one another to vary a length of the boom assembly 508. The boom assembly 508 further includes a second boom section or four bar linkage, shown as upper boom 542. The upper boom 542 may include structural members that rotate relative to one another to raise and lower a distal end of the boom assembly 508. In other embodiments, the boom assembly 508 includes more or fewer boom sections (e.g., one, three, five, etc.) and/or a different arrangement of boom sections.

As shown in FIG. 6, the boom assembly 508 includes a first actuator, shown as lower lift cylinder 544. The lower boom 540 is pivotally coupled (e.g., pinned, etc.) to the turntable 504 at a joint or lower boom pivot point. The lower lift cylinder 544 (e.g., a pneumatic cylinder, an electric actuator, a hydraulic cylinder, etc.) is coupled to the turntable 504 at a first end and coupled to the lower boom 540 at a second end. The lower lift cylinder 544 may be configured to raise and lower the lower boom 540 relative to the turntable 504 about the lower boom pivot point.

The boom assembly 508 further includes a second actuator, shown as upper lift cylinder 546. The upper boom 542 is pivotally coupled (e.g., pinned) to the upper end of the lower boom 540 at a joint or upper boom pivot point. The upper lift cylinder 546 (e.g., a pneumatic cylinder, an electric actuator, a hydraulic cylinder, etc.) is coupled to the upper boom 542. The upper lift cylinder 546 may be configured to extend and retract to actuate (e.g., lift, rotate, elevate, etc.) the upper boom 542, thereby raising and lowering a distal end of the upper boom 542.

As shown in FIG. 6, the application kit 80 further includes an operator platform, shown as platform assembly 550, coupled to the distal end of the upper boom 542 by an extension arm, shown as jib arm 552. The jib arm 552 may be configured to pivot the platform assembly 550 about a lateral axis (e.g., to move the platform assembly 550 up and down, etc.) and/or about a vertical axis (e.g., to move the platform assembly 550 left and right, etc.).

According to an exemplary embodiment, the platform assembly 550 provides a platform configured to support one or more operators or users. In some embodiments, the platform assembly 550 includes accessories or tools configured for use by the operators. In one embodiment, the platform assembly 550 includes pneumatic tools (e.g., an impact wrench, airbrush, nail gun, ratchet, etc.), plasma cutters, welders, spotlights, etc. In other embodiments, the platform assembly 550 includes a control panel (e.g., a user interface, a removable or detachable control panel, etc.) configured to control operation of the boom lift 500 (e.g., the turntable 504, the boom assembly 508, etc.) from the platform assembly 550 or remotely. In other embodiments, the platform assembly 550 is omitted, and the boom lift 500 includes an accessory and/or tool (e.g., forklift forks, etc.) coupled to the distal end of the boom assembly 508.

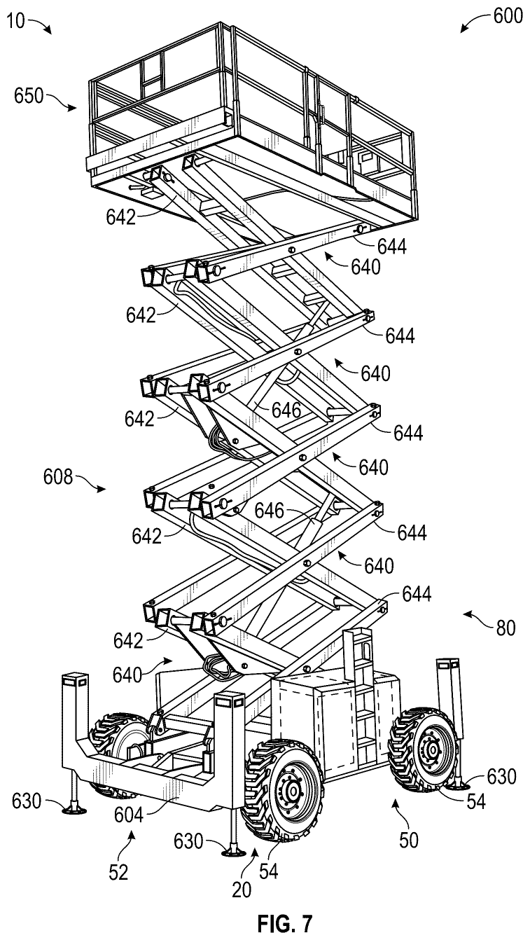

According to an exemplary embodiment, as shown in FIG. 7, the vehicle 10 is configured as a lift device, shown as scissor lift 600. As shown in FIG. 7, the application kit 80 includes a body, shown as lift base 604, coupled to the chassis 20. The lift base 604 is coupled to a scissor assembly, shown as lift assembly 608, such that the lift base 604 supports the lift assembly 608. The lift assembly 608 is configured to extend and retract, raising and lowering between a raised position and a lowered position relative to the lift base 604.

As shown in FIG. 7, the lift base 604 includes a series of actuators, stabilizers, downriggers, or outriggers, shown as leveling actuators 630. The leveling actuators 630 may extend and retract vertically between a stored position and a deployed position. In the stored position, the leveling actuators 630 may be raised, such that the leveling actuators 630 do not contact the ground. Conversely, in the deployed position, the leveling actuators 630 may engage the ground to lift the lift base 604. The length of each of the leveling actuators 630 in their respective deployed positions may be varied in order to adjust the pitch (e.g., rotational position about a lateral axis) and the roll (e.g., rotational position about a longitudinal axis) of the lift base 604 and/or the chassis 20. Accordingly, the lengths of the leveling actuators 630 in their respective deployed positions may be adjusted to level the lift base 604 with respect to the direction of gravity (e.g., on uneven, sloped, pitted, etc. terrain). The leveling actuators 630 may lift the wheel and tire assemblies 54 off of the ground to prevent movement of the scissor lift 600 during operation. In other embodiments, the leveling actuators 630 are omitted.

According to an exemplary embodiment, the lift assembly 608 includes a series of subassemblies, shown as scissor layers 640, each including a pair of inner members 642 and a pair of outer members 644. The scissor layers 640 may be stacked atop one another in order to form the lift assembly 608. The inner members 642 may be pivotally coupled to the outer members 644 near the center of both the inner members 642 and the outer members 644. In this regard, the inner members 642 may pivot relative to the outer members 644 about a lateral axis. Each of the inner members 642 and the outer members 644 may include a top end and a bottom end. The bottom end of each inner member 642 may be pivotally coupled to the top end of the outer member 644 immediately below it, and the bottom end of each outer member 644 may be pivotally coupled to the top end of the inner member immediately below it. Accordingly, each of the scissor layers 640 may be coupled to one another such that movement of one scissor layer 640 causes a similar movement in all of the other scissor layers 640. The bottom ends of the inner member 642 and the outer member 644 that make up the lowermost scissor layer 640 may be coupled to the lift base 604. The top beds of the inner member 642 and the outer member 644 that make up the uppermost scissor layer 640 may be coupled to the platform assembly 650. In some embodiments, scissor layers 640 may be added to, or removed from, the lift assembly 608 in order to increase, or decrease, the fully extended height of the lift assembly 608.

As shown in FIG. 7, the lift assembly 608 also includes one or more lift actuators 646 (e.g., hydraulic cylinders, pneumatic cylinders, motor-driven leadscrews, etc.) configured to extend and retract the lift assembly 608. The lift actuators 646 may be pivotally coupled to an inner member 642 at a first end and pivotally coupled to an inner member 642 of another scissor layer 640 at a second end. In an exemplary embodiment, these inner members 642 belong to a first scissor layer 640 and a second scissor layer 640 (which may be separated by a third scissor layer 640). In other embodiments, the lift actuators 646 are arranged in other configurations (e.g., the first scissor layer 640 and the second scissor layer 640 are not separated by a third scissor layer 640, etc.).

According to an exemplary embodiment, as distal or upper end of the lift assembly 608 is coupled to an operator platform, shown as platform assembly 650. The lift actuators 646 may be configured to actuate the lift assembly 608 to selectively reposition the platform assembly 650 between a lowered position (e.g., where the platform assembly 650 is proximate to the lift base 604) and a raised position (e.g., where the platform assembly 650 is at an elevated height relative to the lift base 604). Specifically, in some embodiments, extension of the lift actuators 646 moves the platform assembly 650 upward (e.g., extending the lift assembly 608), and retraction of the lift actuators 646 moves the platform assembly 650 downward (e.g., retracting the lift assembly 608). In other embodiments, extension of the lift actuators 646 retracts the lift assembly 608, and retraction of the lift actuators 646 extends the lift assembly 608. In some embodiments, the outer members 644 are parallel to and/or in contact with one another when the lift assembly 608 is in the stored position.

In some embodiments, the platform assembly 650 includes a platform that is configured to support one or more operators or users. Similar to the platform assembly 550, the platform assembly 650 may include accessories or tools (e.g., pneumatic tools, plasma cutters, welders, spotlights, etc.) configured for use by an operator. The platform assembly 650 may include a control panel to control operation of the scissor lift 600.

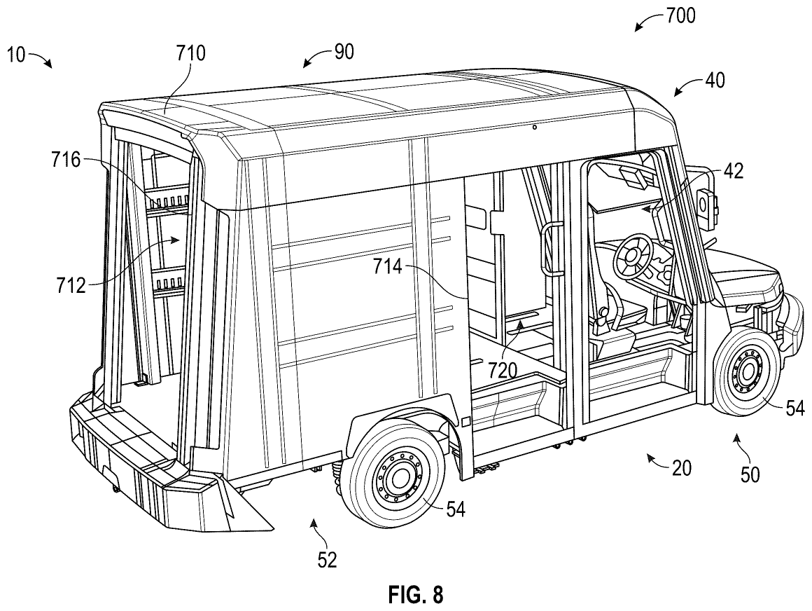

As shown in FIG. 8, the vehicle 10 is configured as a delivery vehicle 700 (e.g., a parcel vehicle, a cargo transport vehicle, a mail vehicle, a postal vehicle, a postal van, a truck, a van, etc.). Specifically, the delivery vehicle 700 is a delivery vehicle with a hatch door. In other embodiments, the delivery vehicle 700 does not include a hatch door.

As shown in FIG. 8, the application kit 90 includes a rear storage section, shown as cargo body 710. The cargo body 710 defines an interior section or zone, shown as cargo compartment 712, a first opening, shown as side cargo opening 714, and a second opening, shown as rear cargo opening 716. The side cargo opening 714 is positioned along a right side of the of the delivery vehicle 700 and facilitates ingress into and egress from the cargo compartment 712 from the right side of the delivery vehicle 700. The rear cargo opening 716 is positioned at a rear end of the delivery vehicle 700 and facilitates ingress into and egress from the cargo compartment 712 from the rear end of the delivery vehicle 700. The cargo compartment 712 is configured to receive and store parcels (e.g., mail, packages, etc.) for transport and delivery via the delivery vehicle 700. In some embodiments, the cargo compartment 712 includes cabinets, shelves, racks, and/or other storage devices to facilitate organizing and securing the parcels within the cargo compartment 712.

As shown in FIG. 8, the application kit 90 defines an opening, shown as passageway 720, that connects the cab interior 42 to the cargo compartment 712. In some embodiments, the application kit 90 includes a door or gate that at least partially and selectively encloses the passageway 720. In other embodiments, the application kit 90 includes a full partition that completely segregates the cab interior 42 from the cargo compartment 712.

### Swappable Battery Architecture

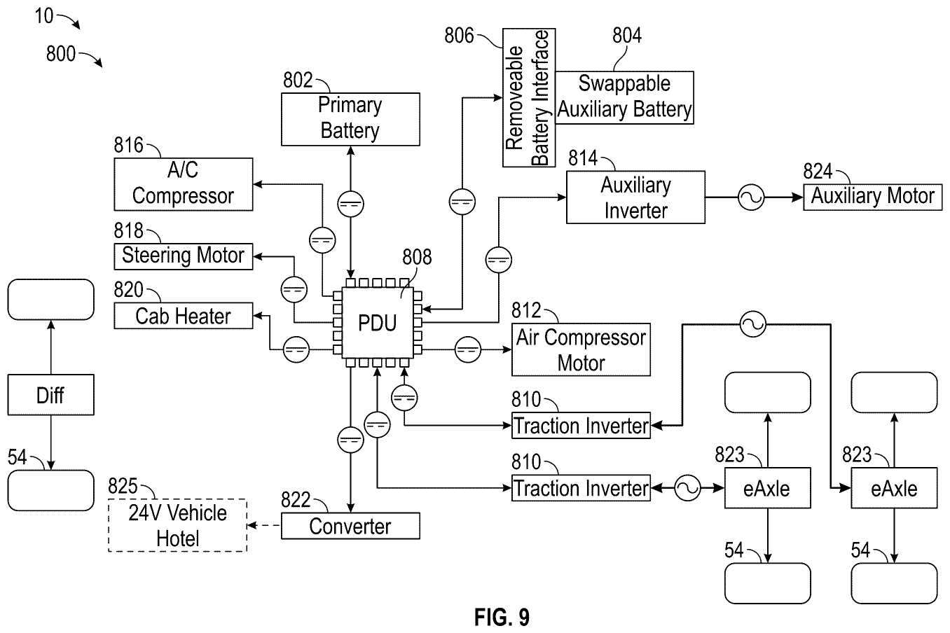

FIG. 9 illustrates an electrical power system 800 of a vehicle (e.g., an electrified vehicle, a commercial vehicle, a refuse vehicle, a fire fighting vehicle, a fire suppression vehicle, a military vehicle, a mixing vehicle, a lift vehicle, a delivery vehicle, a vocational vehicle, the vehicle 10 etc.). In some embodiments, the electrical power system 800 is included on any configuration of the vehicle 10 described herein. In general, the electrical power system 800 includes a primary battery 802 (e.g., a battery pack, an energy storage system, etc.) and a swappable auxiliary battery 804 that is configured to selectively be connected to the electrical power system 800 by a battery interface 806. In some embodiments, the electrical power system 800 is provided on a fully-electric vehicle. In some embodiments, the electrical power system 800 is provided on a vehicle with a hybrid powertrain.

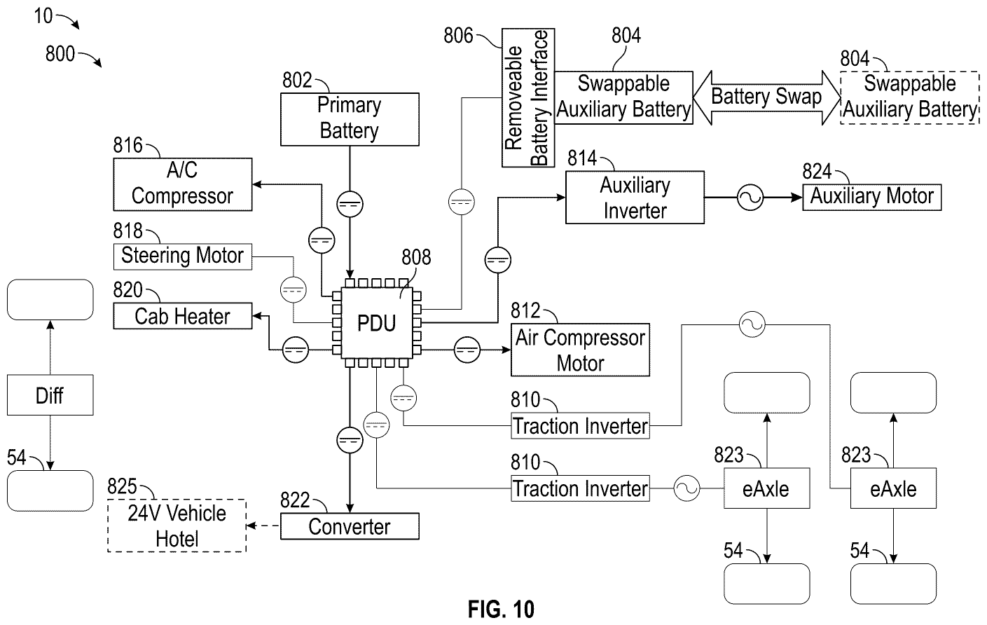

The electrical power system 800 includes a power distribution unit (PDU) 808 that is configured to receive electrical power from the primary battery 802 and the swappable auxiliary battery 804 (when connected) and supply the electrical power to the various electrical components of the vehicle 10. In some embodiments, the PDU 808 includes various power electronics (e.g., inverter circuits, rectifier circuits, converter circuits, boost-buck circuits, contactors, switches, controllers (processors and memory), input/output modules, bus interfaces, wiring assemblies/harnesses, connectors, etc.). The PDU 808 is configured to supply electrical power to one or more traction inverters 810, an air compressor motor 812, an auxiliary inverter 814, an A/C compressor 816, a steering motor 818, a cab heater 820, and a low voltage converter 822, with the arrows in FIG. 9 (and FIGS. 10-21) indicating a direction of mechanical or electrical power being supplied. The one or more traction inverters 810 each supply electrical power to corresponding electronic axle (e-axle) 823, which include electronic drive motors. The auxiliary inverter 814 supplies electrical power to an auxiliary motor 824 (e.g., that powers the drum drive system 234, the turntable 342, the lift assembly 608, or any other auxiliary component (e.g., non-drive wheel component) on any configurations of the vehicle 10 described herein). The A/C compressor 816 is selectively powered to supply cooling to the HVAC system in the cab, and the cab heater 820 is selectively powered to supply heating to the HVAC system in the cab. The low voltage converter 822 is configured to step down the high voltage power from the PDU 808 to a lower voltage (e.g., 24V) to supply power to the low-voltages components 825 of the vehicle 10 (e.g., displays, controllers, lights, etc.).

Referring now to FIG. 10, an illustration of the electrical power system 800 during a battery swap is shown. As shown in FIG. 10, during a swap, the swappable auxiliary battery 804 is disengaged (e.g., removed, etc.) from the electrical power system 800 via the battery interface 806. That is, during a battery swap, the swappable auxiliary battery 804 is removed from the battery interface 806. In some embodiments, the electrical power system 800 may include a plurality of the swappable auxiliary batteries 804, such that, the electrical power system 800 can selectively disengage a first swappable auxiliary battery 804 and engage a second swappable auxiliary battery 804. This battery swap operation may be performed periodically based on a plurality of parameters regarding the swappable auxiliary battery 804, the electrical power system 800, and the vehicle 10. For example, responsive to the state of charge of a first swappable auxiliary battery 804 falling below a predetermined threshold, an operator may swap the first swappable auxiliary battery 804 for a second swappable auxiliary battery 804. In some embodiments, the battery swap may be performed automatically by a component of the vehicle 10 and/or the electrical power system 800. For example, responsive to a first swappable auxiliary battery 804 not providing enough electrical power, the PDU 808 may operate the battery interface 806 to disengage the first swappable auxiliary battery 804 and selectively engage a second swappable auxiliary battery 804, thereafter operating the electrical power system 800 using electrical power from the second swappable auxiliary battery 804.

During a battery swap, where the swappable auxiliary battery 804 is swapped out for a different swappable auxiliary battery 804 (e.g., swapping out a low state of charge (SOC) or depleted battery for a high SOC or charged battery), the PDU 808 may communicate with the battery interface 806 to detect that the swappable auxiliary battery 804 is removed from the battery interface 806. In response, the PDU 808 may disable some components but maintain auxiliary power during the battery swap. For example, as illustrated in FIG. 10, the primary battery 802 may supply electrical power to the air compressor motor 812, the auxiliary inverter 814, the A/C compressor 816, the cab heater 820, and the low voltage converter 822 during the battery swap. The traction inverters 810 and the steering motor 818 may be disabled during the battery swap.

The PDU 808 may detect that a different swappable auxiliary battery 804 has been engaged with the electrical power system 800 at the battery interface 806 (e.g., the battery swap is complete). Responsive to detecting that the battery swap is complete, the PDU 808 may return to providing power to all elements of the electrical power system 800. That is, the PDU 808 may begin to provide electrical power to the one or more traction inverters 810 and the steering motor 818.

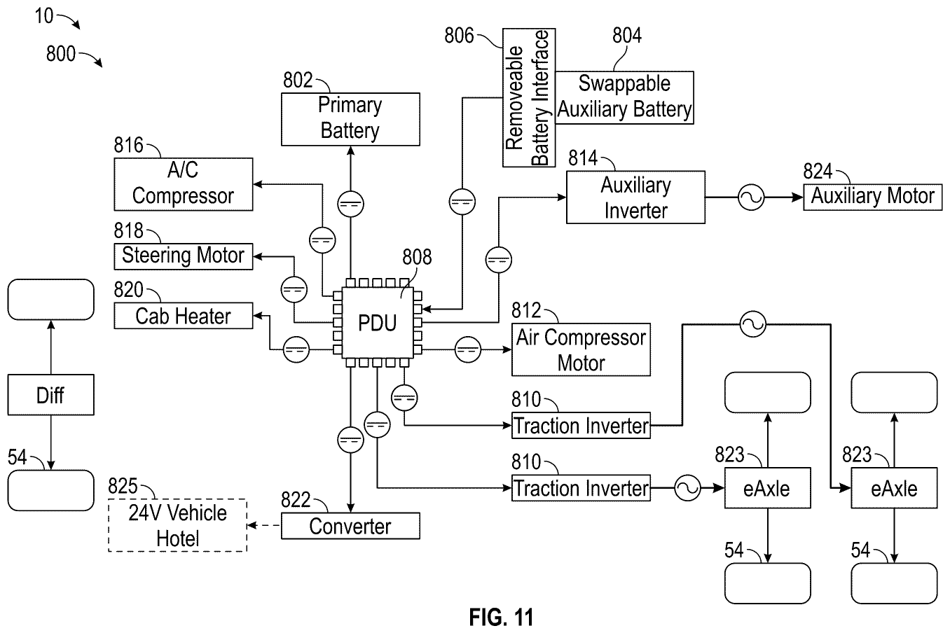

As shown in FIG. 11, when the swappable auxiliary battery 804 is installed on the battery interface 806, the swappable auxiliary battery 804 may be used to charge the primary battery 802. In some embodiments, the PDU 808 may operate the swappable auxiliary battery 804 such that the components of the electrical power system 800 may receive electrical power required to perform their respective operations while simultaneously providing electrical power to the primary battery 802 to charge the primary battery 802. In some embodiments, the swappable auxiliary battery 804 is configured to supply electrical power to the primary battery 802 through the PDU 808, and the primary battery 802 provides electrical to the PDU 808 and the components of the vehicle 10. In some embodiments, the PDU 808 may operate the swappable auxiliary battery 804 to charge the primary battery 802 while the vehicle 10 is moving (e.g., being driven, etc.). In some embodiments, the PDU 808 is configured to step up or step down the voltage output by the swappable auxiliary battery 804 to charge the primary battery 802.

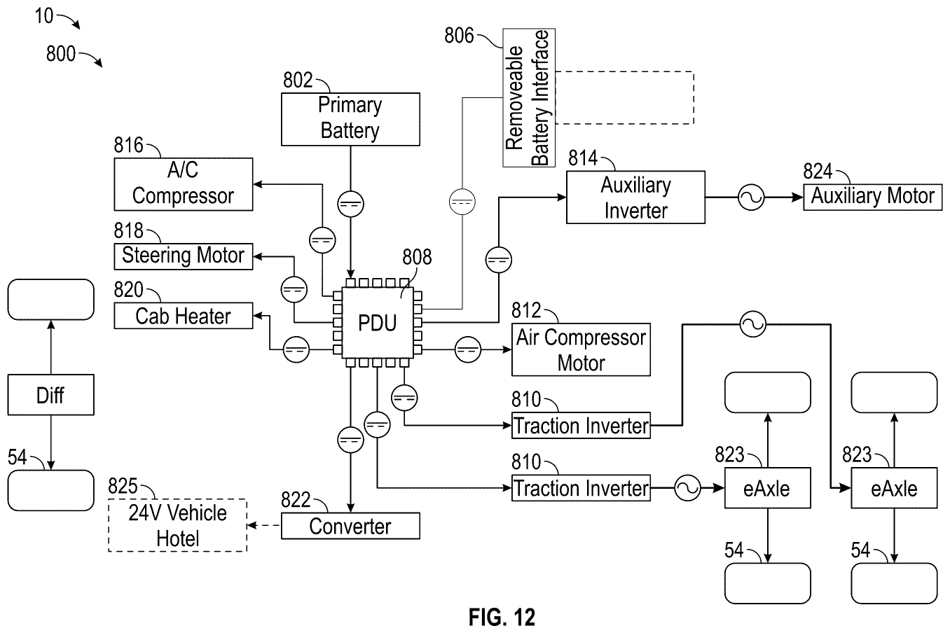

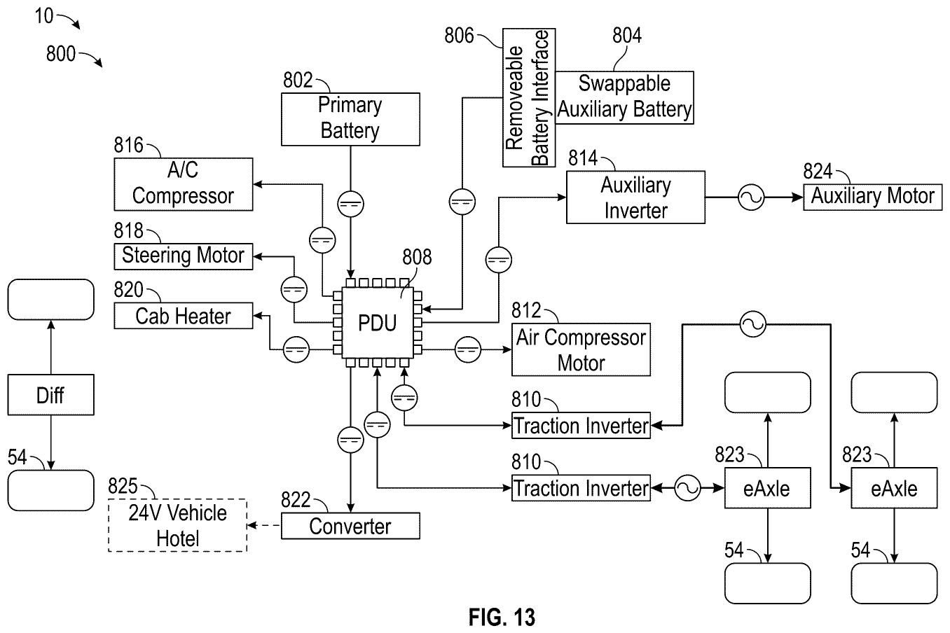

When the swappable auxiliary battery 804 is removed from the battery interface 806, as shown in FIG. 12, the vehicle 10 is still operational with the primary battery 802 supplying all of the electrical power to the PDU 808. In this configuration, the operational range/duration of the vehicle 10 may be reduced (e.g., how far or long the vehicle 10 can operate prior to charging the primary battery 802 and/or swapping the swappable auxiliary battery 804), when compared to the swappable auxiliary battery 804 being installed on the battery interface 806 and the fully operating range/duration is available (see, e.g., FIG. 13).

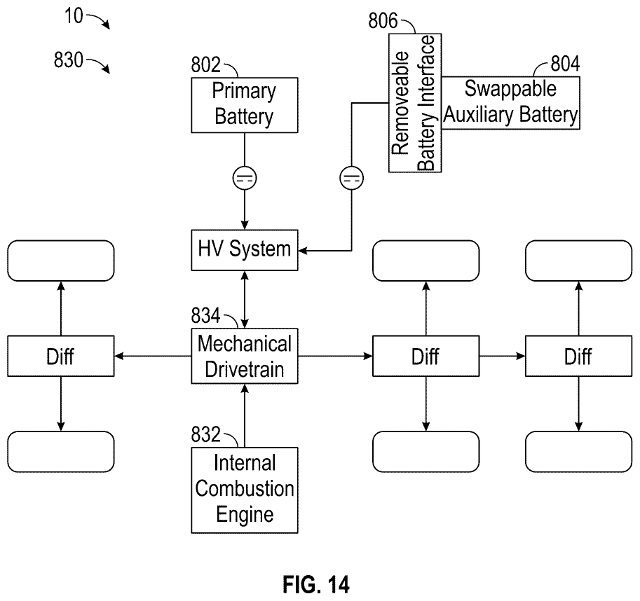

In some embodiments, the swappable auxiliary battery 804 and the battery interface 806 may be integrated into a hybrid drivetrain 830 on the vehicle 10, as shown in FIG. 14. In general, the vehicle 10 may normally operate with the primary battery 802 and an internal combustion engine 832 supplying power to a mechanical drivetrain 834. The swappable auxiliary battery 804 may be installed as a range extender by increasing the overall electrical capacity of the hybrid drivetrain 830. In general, including the swappable auxiliary battery 804 within the electrical power system 800 and the hybrid drivetrain 830 enables the electrical components of the vehicle 10 to define a reduced weight and more efficient packaging because only the swappable auxiliary battery 804 needs to be accessible, while the primary battery 802 can be hardwired and fixed on the vehicle 10. And the swappable auxiliary battery 804 enables the operational range/duration of the vehicle 10 to be extended.

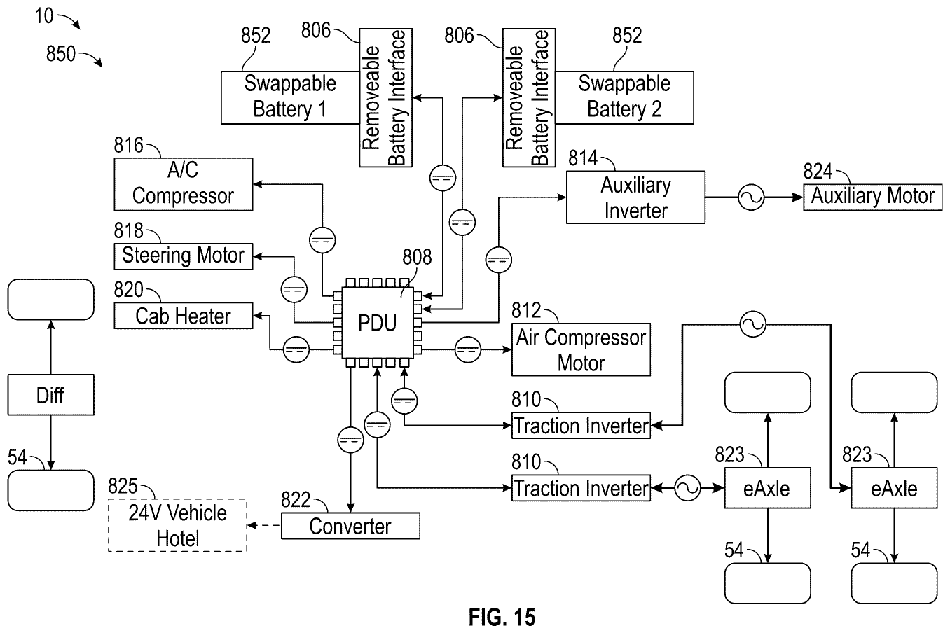

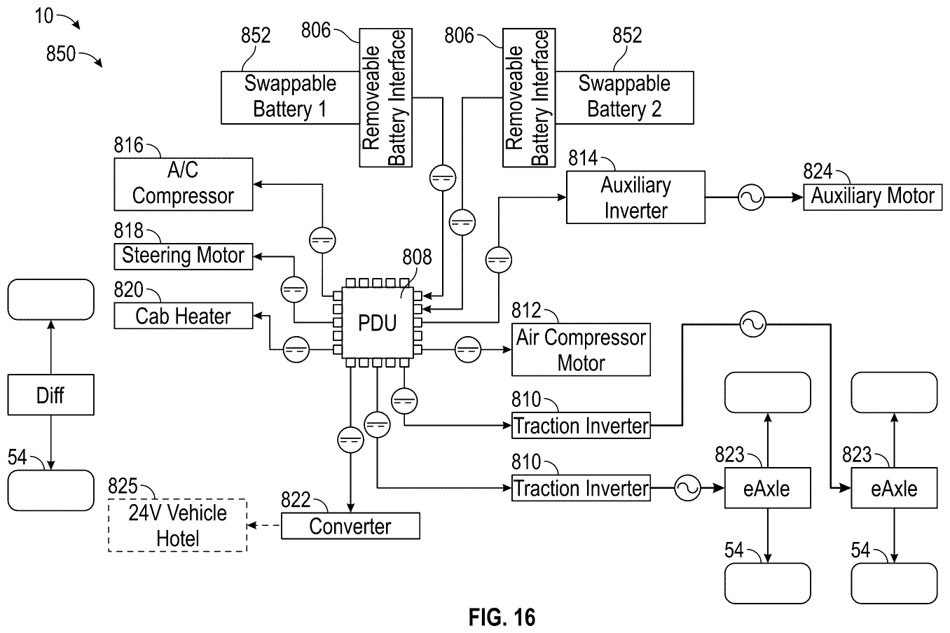

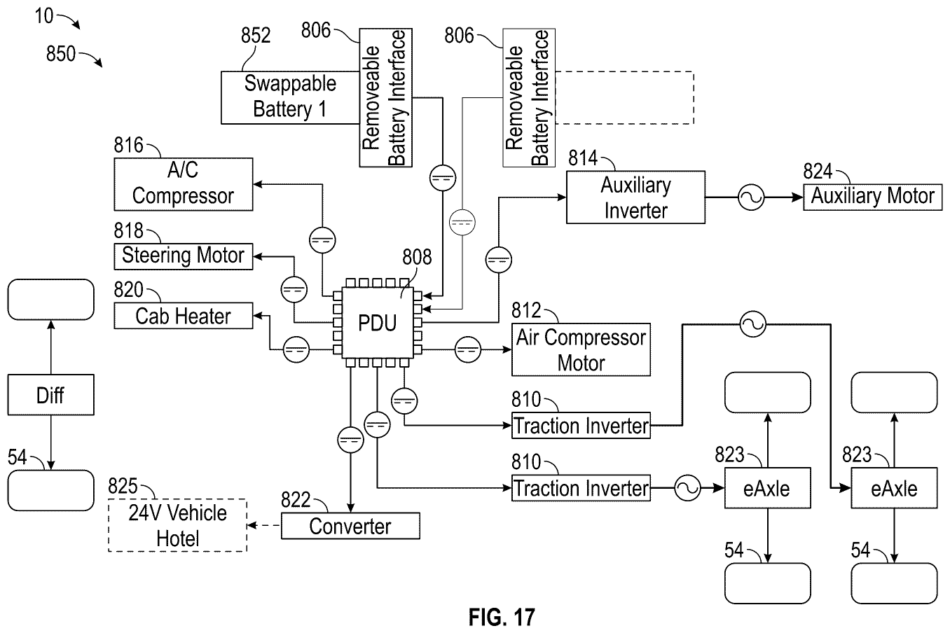

FIG. 15 illustrates an electrical power system 850 of a vehicle (e.g., an electrified vehicle, a commercial vehicle, a refuse vehicle, a fire fighting vehicle, a fire suppression vehicle, a military vehicle, a mixing vehicle, a lift vehicle, a delivery vehicle, a vocational vehicle, the vehicle 10 etc.). In some embodiments, the electrical power system 850 is included on any configuration of the vehicle 10 described herein. In general, the electrical power system 850 is similar to the electrical power system 800, with like features identified using similar reference numerals, except as described herein or apparent from the figures. The electrical power system 850 does not include a primary battery 802 and instead includes one or more swappable batteries 852 that supply all of the electrical power to the PDU 808. In some embodiments, the electrical power system includes two swappable batteries 852. When both of the swappable batteries 852 are installed on their respective battery interfaces 806 (see, e.g., FIG. 16), the electrical power system 850 provides a full operational range/duration to the vehicle 10. If one of the swappable batteries 852 is removed (see, e.g., FIG. 17), the electrical power system 850 provides a reduced operational range/duration to the vehicle 10. In some embodiments, either of the swappable batteries 852 may be selectively removed from the electrical power system 850. For example, a first swappable batteries 852 may be removed from the electrical power system 850 while a second swappable batteries 852 remains coupled to the electrical power system 850, such that the second swappable batteries 852 supplies the electrical power for the operations of the vehicle 10. In some embodiments, the swappable batteries 852 may be or include electrical power sources similar to the swappable auxiliary battery 804. As shown in FIG. 15, the swappable batteries 852 are removably coupled with the battery interface 806 such that either one of the swappable batteries 852 may be selectively removed from and coupled to the electrical power system 850.

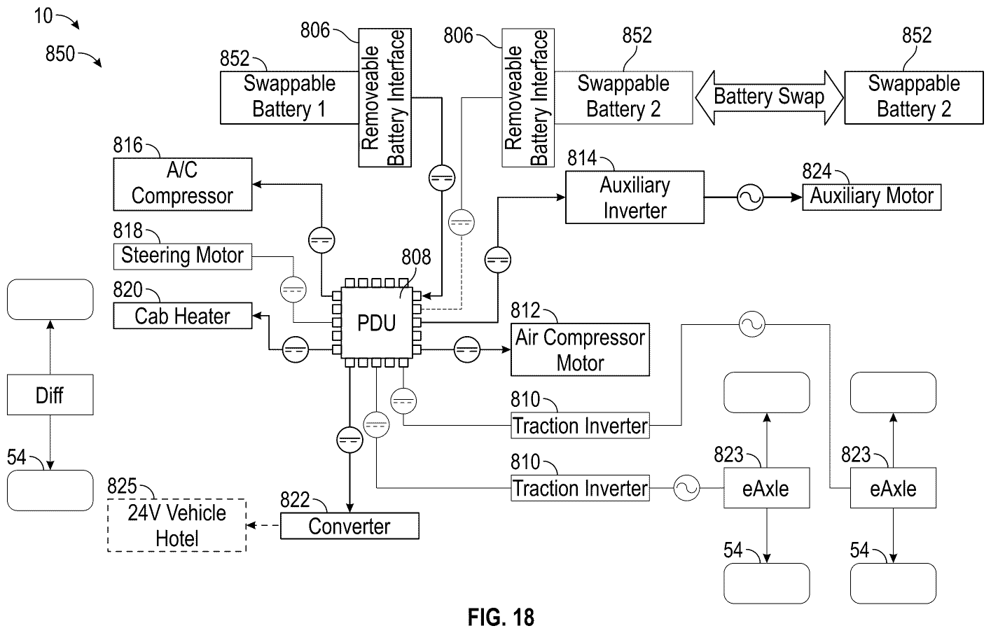

Referring now to FIG. 18, an illustration of the electrical power system 850 during a battery swap is shown. As shown in FIG. 18, during a battery swap, one of the swappable batteries 852 is disengaged from the electrical power system 850. That is, during a battery swap, one of the swappable batteries 852 is removed from the battery interface 806. In some embodiments, the electrical power system 850 may include a plurality of swappable batteries 852, such that, a first of the swappable batteries 852 may be disengaged and replaced by a third of the swappable batteries 852, while a second of the swappable batteries 852 supplied the electrical power to the electrical power system 850 while the first of the swappable batteries 852 and the third of the swappable batteries 852 are not coupled to the electrical power system 850.

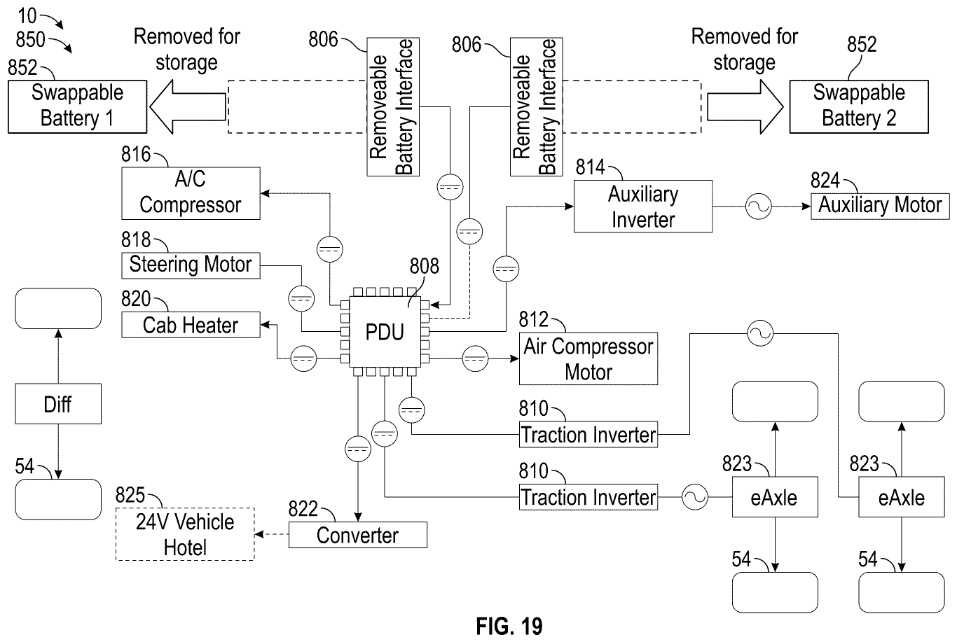

During a battery swap, where the one of the swappable batteries 852 is swapped out for a different swappable battery 852 (e.g., swapping out a low state of charge (SOC) or depleted battery for a high SOC or charged battery), the PDU 808 may communicate with the battery interface 806 to detect that the swappable battery 852 is removed from the battery interface 806. In response, the PDU 808 may disable some components but maintain auxiliary power during the battery swap. For example, as illustrated in FIG. 18, the swappable battery 852 that remains connected may supply electrical power to the air compressor motor 812, the auxiliary inverter 814, the A/C compressor 816, the cab heater 820, and the low voltage converter 822 during the battery swap. The traction inverters 810 and the steering motor 818 may be disabled during the battery swap. In some embodiments, both of the swappable batteries 852 may be removed to allow the vehicle 10 to be stored, as shown in FIG. 19.

In general, including the swappable batteries 852 within the electrical power system 850 enables the vehicle 10 to achieve 100% SOC after swapping batteries, and the vehicle 10 can be stored separately from the swappable batteries 852. In addition, the swappable batteries 852 can be maintained/serviced without the vehicle 10 being present, and the vehicle 10 does not have an effect on the end-of-life for the swappable batteries 852 and vice versa. The vehicle 10 may also be adapted for new battery chemistry/technology or vice versa.

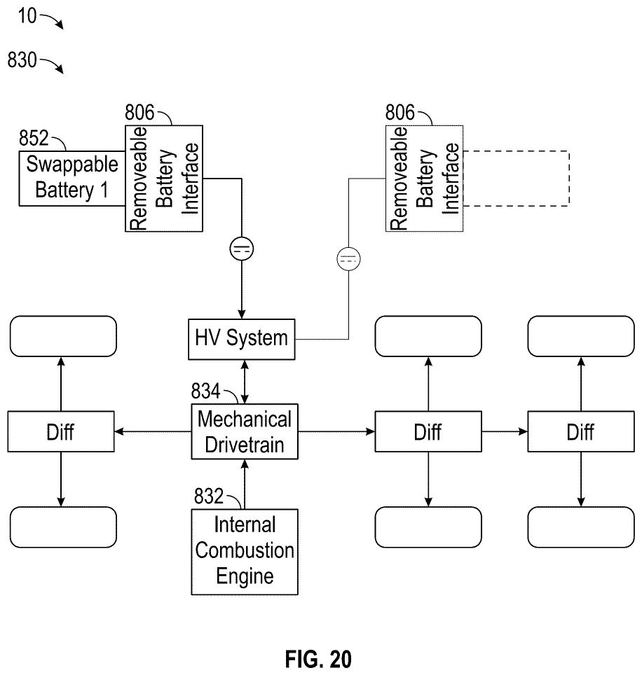

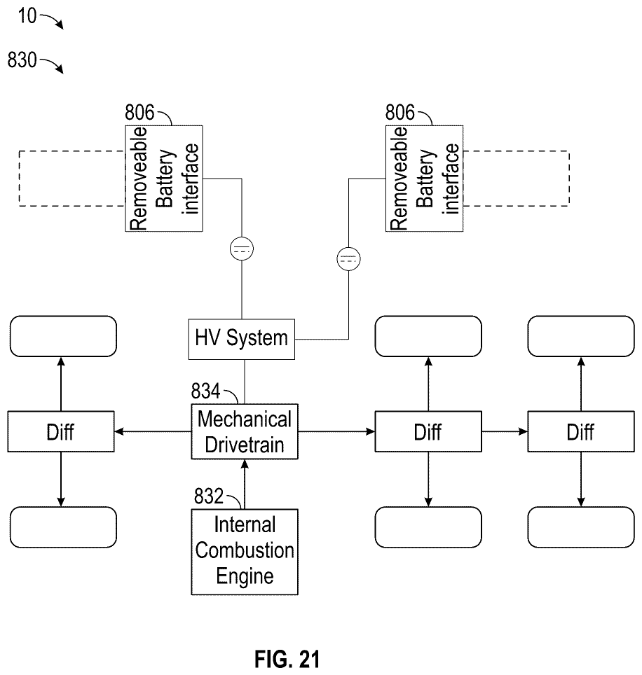

In some embodiments, the swappable batteries 852 may be integrated into the hybrid drivetrain 830 on the vehicle 10, as shown in FIG. 20. In general, the vehicle 10 may normally operate with at least one of the swappable batteries 852 and the internal combustion engine 832 supplying power to a mechanical drivetrain 834. If both of the swappable batteries 852 are installed, the range may be extended when compared to having only one of the swappable batteries 852 installed. If both of the swappable batteries 852 are removed (see, e.g., FIG. 21), the hybrid drivetrain 830 may operate in an engine-only mode where the internal combustion engine supplies power to the mechanical drivetrain 834. Accordingly, the hybrid drivetrain 830 can run in engine-only mode, a hybrid mode, or a hybrid mode with extended range depending on the swappable battery architecture.

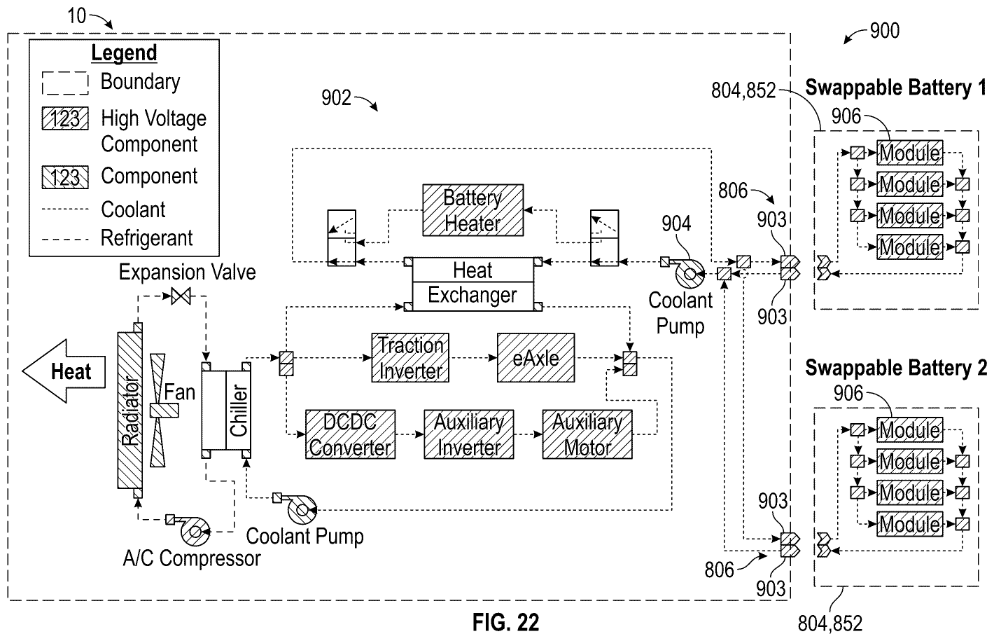

In some embodiments, the battery interface 806 described herein may be configured to provide pass-through cooling to the swappable batteries described herein (e.g., the swappable auxiliary battery 804 and the swappable battery 852). For example, the battery interface 806 may include one or more ports that allow for cooling fluid (e.g., coolant) to be passed from the vehicle 10 to the battery. FIG. 22 illustrates an exemplary embodiment of a pass-through cooling system 900 where a vehicle cooling circuit 902 passes cooling fluid (e.g., coolant) to the swappable batteries 852. Specifically, the battery interfaces 806 both include cooling ports 903 that pass cooling fluid to and from the swappable batteries 852 so that battery modules 906 (e.g., an array of battery cells) are cooled. In some embodiments, a coolant pump 904 on the vehicle 10 supplies fluid flow to the cooling ports 903 of the battery interfaces 806.

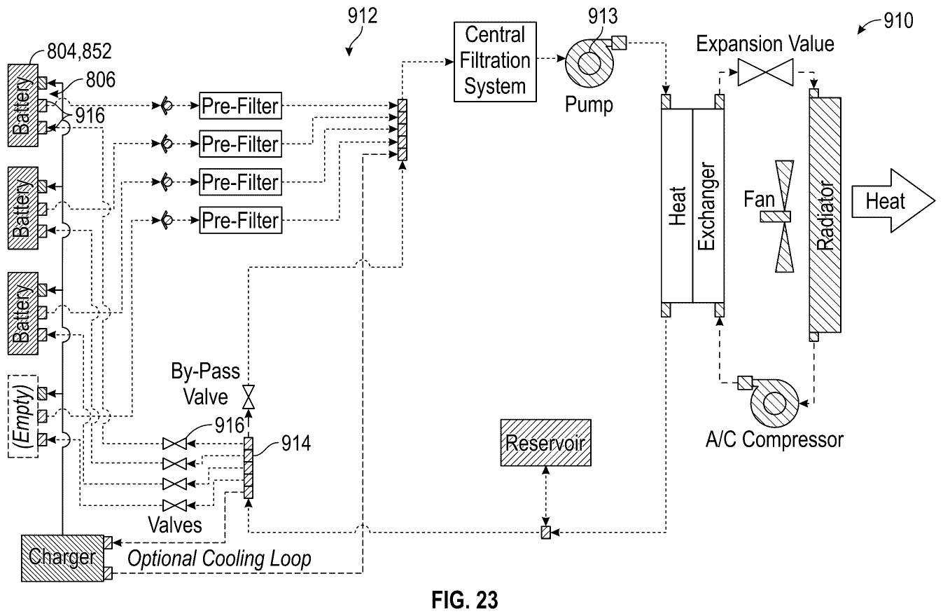

In some embodiments, with the cooling ports 903 being arranged on the battery interface 806, the pass-through cooling may be integrated into a charge cooling system 910 of a charging station 912, as shown in FIG. 23. The charge cooling system 910 may include a pump 913 that supplies cooling fluid to a cooling manifold 914. A valve 916 (e.g., on-off valve, ball valve, electric valve, etc.) is configured to selectively inhibit or provide cooling fluid from the cooling manifold 914 to the cooling ports 903 on the battery interface 806 at each dock on the charging station 912.

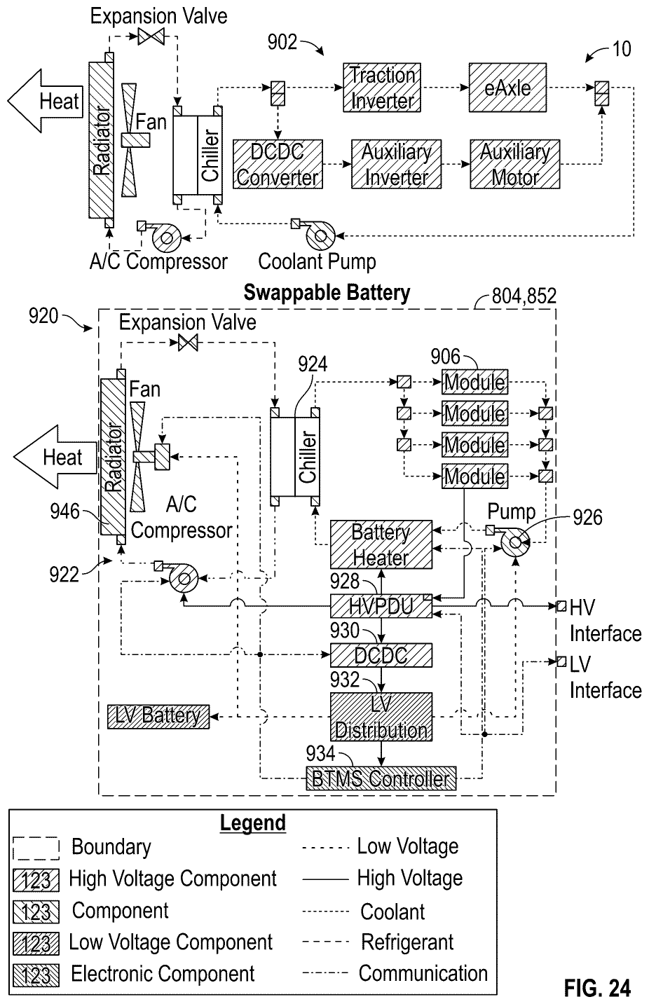

In some embodiments, the vehicle cooling circuit 902 may be separated from a battery cooling system, as shown in FIG. 24. That is, the swappable batteries described herein (e.g., the swappable auxiliary battery 804 and the swappable battery 852) may each include a native or built-in battery cooling system 920 arranged internal to the swappable battery. In some embodiments, the built-in battery cooling system 920 includes a refrigeration circuit 922 (e.g., compressor, radiator, expansion valve, evaporator/chiller) that supplies evaporative cooling to a chiller 924 and receives cooling fluid (e.g., coolant) from a pump 926. The pump 926 circulates the cooling fluid to provide cooling to the battery modules 906. In some embodiments, the swappable battery (e.g., the swappable auxiliary battery 804 and the swappable battery 852) includes a high-voltage PDU 928 that supplies electrical power a DC-to-DC converter 930, and the DC-to-DC converter 930 supplies low voltage power to a low-voltage PDU 932. A battery thermal management controller 934 (e.g., a processor having memory) is configured to control the refrigeration circuit 922 (e.g., the compressor and a fan blowing on the radiator) and the pump 926.

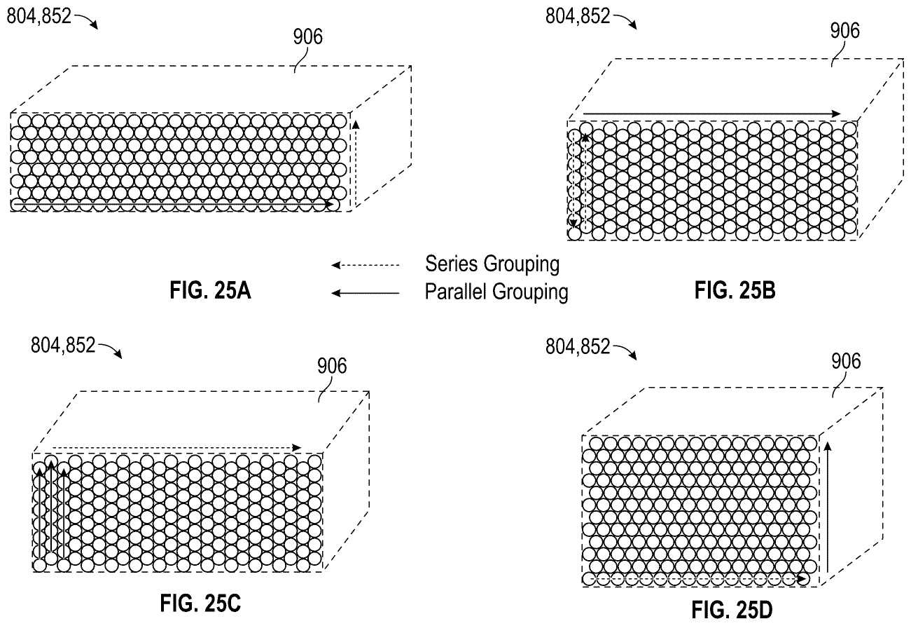

In some embodiments, the swappable batteries described herein (e.g., the swappable auxiliary battery 804 and the swappable battery 852) include battery modules 906, where each of the battery modules 906 includes a plurality of battery cells wired in a particular configuration. FIGS. 25A-D illustrate various exemplary embodiments of the battery module 906 including a 16-series, 24-parallel (16 s 24 p) battery cell wiring configuration. In some embodiments, the swappable batteries described herein (e.g., the swappable auxiliary battery 804 and the swappable battery 852) include eleven of the battery modules 906 wired in series, where each of the battery modules 906 include a nominal voltage of about 57V, a maximum voltage of about 67V and a minimum voltage of about 40V. In some embodiments, each of the battery modules 906 include an energy capacity of about 6.9 kW-h. In some embodiments, the swappable batteries described herein (e.g., the swappable auxiliary battery 804 and the swappable battery 852) that include eleven of the battery modules 906 defines a nominal voltage of about 630V, a maximum voltage of about 740V, and a minimum voltage of about 440V, and an energy capacity of about 76 kW-h.

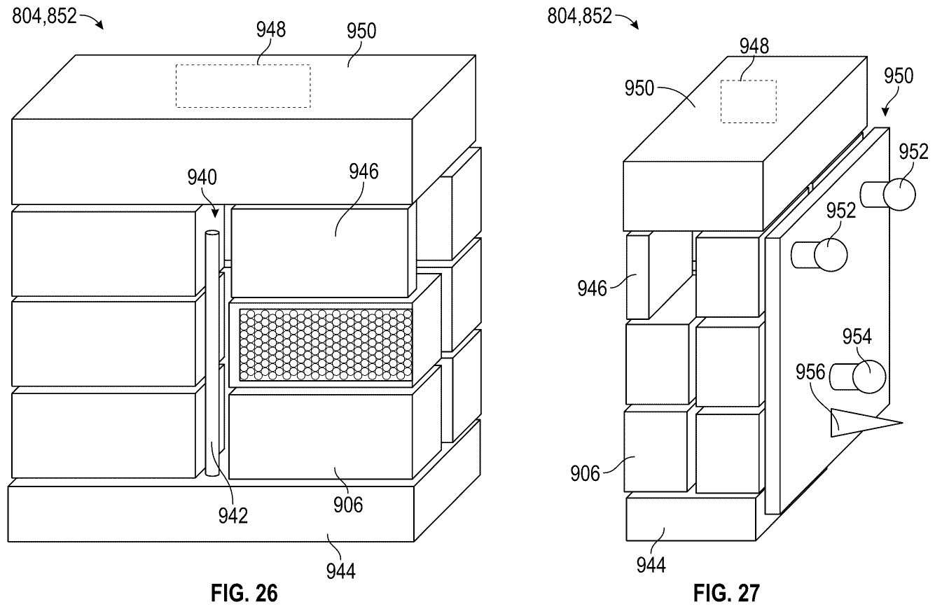

FIGS. 26 and 27 illustrated an exemplary embodiment layout of the swappable auxiliary battery 804 and/or the swappable battery 852. The swappable auxiliary battery 804 and/or the swappable battery 852 may include eleven of the battery modules 906 that are spaced from one another so that a cooling gap 940 is arranged therebetween for routing cooling lines 942. In some embodiments, a thermal management system 944 may be mounted below the battery modules 906 (e.g., in embodiments using the built-in battery cooling system 920). In some embodiments, the thermal management system 944 includes various pumps, valves, etc. that are included within the built-in battery cooling system 920. Also, in embodiments where the built-in battery cooling system 920 is implemented, a radiator 946 of the refrigeration circuit 922 may be mounted in the array of battery modules 906. In some embodiments, a battery management module 948 is mounted on top of the battery modules 906. In some embodiments, the battery management module 948 includes a battery management system (e.g., a controller with a processor having memory), the battery thermal management controller 934 (e.g., in embodiments using the built-in battery cooling system 920), and the high-voltage PDU 928. In some embodiments, a battery interface 950 is mounted on a side of the swappable auxiliary battery 804 and/or the swappable battery 852. The battery interface 950 may include high voltage connectors 952 (e.g., positive and negative connectors), a low voltage communication interface 954, and a cooling connector 956 (e.g., hot stab connector).

In some embodiments, the swappable auxiliary battery 804 and/or the swappable batteries 852 may be in the form of an alternative power source. For example, the swappable auxiliary battery 804 and/or the swappable batteries 852 may be in the form of a fuel cell that is used to selectively provide or supplement an electrical capacity of the vehicle 10.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the electrical power systems and cooling systems as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A vocational vehicle, comprising:
a chassis;
a plurality of tractive elements coupled to the chassis;
a plurality of electric axles coupled to at least one of the plurality of tractive elements;
a battery interface;
a swappable battery configured to be selectively connected to or removed from the battery interface; and
a power distribution unit configured to receive electrical power from the swappable battery and supply the electrical power to the plurality of electric axles.

2. The vocational vehicle of claim 1, further comprising a primary battery.

3. The vocational vehicle of claim 2, wherein the power distribution unit is configured to receive electrical power from the swappable battery and the primary battery.

4. The vocational vehicle of claim 1, wherein the swappable battery is configured to be removed from the battery interface and be replaced by a second swappable battery.

5. The vocational vehicle of claim 1, further comprising:
a primary battery electrically coupled to the power distribution unit and configured to exchange electrical power with the power distribution unit;
an auxiliary inverter electrically coupled to the power distribution unit and configured to operate an auxiliary motor;
an air compressor motor;
one or more traction inverters electrically coupled to the power distribution unit and configured to operate the plurality of electric axles;
an A/C compressor;
a steering motor;
a cab heater; and
a low voltage converter.

6. The vocational vehicle of claim 5, wherein the power distribution unit is configured to:
detect that the swappable battery is removed from the battery interface; and
responsive to detecting that the swappable battery is removed from the battery interface:
receive electrical power from the primary battery;
provide the electrical power to the auxiliary inverter, the air compressor motor, the low voltage converter, the cab heater, and the A/C compressor; and
stop providing electrical power to the one or more traction inverters and the steering motor.

7. The vocational vehicle of claim 5, wherein the power distribution unit is configured to:
receive electrical power from the primary battery and the swappable battery; and
provide the electrical power to the auxiliary inverter, the air compressor motor, the one or more traction inverters, the low voltage converter, the A/C compressor, the steering motor, and the cab heater.

8. The vocational vehicle of claim 1, wherein the battery interface further comprises a cooling port configured to receive cooling fluid and supply the cooling fluid to the swappable battery.

9. The vocational vehicle of claim 1, wherein the swappable battery includes a built-in battery cooling system configured to supply cooling to a battery module.

10. The vocational vehicle of claim 1, further comprising an internal combustion engine and a mechanical drivetrain.

11. A vocational vehicle, comprising:
a chassis;
a plurality of tractive elements coupled to the chassis;
an electric axle coupled to at least one of the plurality of tractive elements;
a primary battery;
a battery interface;
a swappable battery configured to be selectively connected to or removed from the battery interface; and
a power distribution unit configured to receive electrical power from the swappable battery and selectively supply the electrical power to the electric axle, wherein the power distribution unit is configured to detect that the swappable battery is removed from the battery interface and inhibit the primary battery from providing electrical power to the electric axle.

12. The vocational vehicle of claim 11, further comprising:
an auxiliary inverter electrically coupled to the power distribution unit and configured to operate an auxiliary motor;
an air compressor motor;
one or more traction inverters electrically coupled to the power distribution unit and configured to operate the electric axle;
an A/C compressor;
a steering motor;
a cab heater; and
a low voltage converter.

13. The vocational vehicle of claim 12, further comprising a plurality of swappable batteries and a plurality of battery interfaces, wherein each of the plurality of swappable batteries is configured to be removably coupled to a respective one of the plurality of battery interfaces.

14. The vocational vehicle of claim 13, wherein the power distribution unit is configured to:
detect that a first swappable battery of the plurality of swappable batteries is removed from a first battery interface of the plurality of battery interfaces; and
responsive to detecting that the first swappable battery is removed from the first battery interface:
receive electrical power from a second swappable battery;
provide the electrical power to the auxiliary inverter, the air compressor motor, the low voltage converter, the cab heater, and the A/C compressor; and
stop providing electrical power to the one or more traction inverters and the steering motor.

15. The vocational vehicle of claim 11, wherein the battery interface further comprises a cooling port configured to receive cooling fluid and supply the cooling fluid to the swappable battery.

16. The vocational vehicle of claim 11, wherein the swappable battery includes a built-in battery cooling system configured to supply cooling to a battery module.

17. A system for powering a vocational vehicle, comprising:
a plurality of battery interfaces;
a plurality of swappable batteries, each being removably coupled to one of the plurality of battery interfaces;
a power distribution unit configured to receive electrical power from the plurality of swappable batteries and provide the electrical power to a plurality of electronic components of the vocational vehicle; and
a cooling system configured to cool the plurality of swappable batteries, wherein each of the plurality of battery interfaces includes a cooling port that enables cooling fluid to flow to and from the plurality of swappable batteries.

18. The system of claim 17, wherein the power distribution unit is configured to detect that a first swappable battery of the plurality of swappable batteries is removed from a first battery interface of the plurality of battery interfaces; and
responsive to detecting that the first swappable battery is removed from the first battery interface:
receive electrical power from a second swappable battery;
provide the electrical power to an auxiliary inverter, an air compressor motor, a low voltage converter, a cab heater, and an AC compressor of the vocational vehicle; and
stop providing electrical power to a traction inverters and a steering motor of the vocational vehicle.

19. The system of claim 17, further comprising a primary battery.

20. The system of claim 19, wherein the power distribution unit is configured to receive electrical power from the plurality of swappable batteries and the primary battery.
